(19) United States
(12) Patent Application Publication
(10) Pub. No.: US 2015/0154042 A1
(43) Pub. Date: Jun. 4, 2015

(54) COMPUTER SYSTEM AND CONTROL METHOD FOR VIRTUAL MACHINE

(71) Applicant: Hitachi, Ltd., Tokyo (JP)

(72) Inventors: Kana Katayama, Tokyo (JP); Hirokazu Ogasawara, Tokyo (JP)

(21) Appl. No.: 14/367,949

(22) PCT Filed: Dec. 4, 2013
(86) PCT No.: PCT/JP2013/082612

§ 371 Date: Jun. 23, 2014

(51) Int. Cl. G06F 9/455

(52) U.S. Cl. CPC G06F 9/45545

(57) ABSTRACT

A first storage apparatus of a first site stores a master image, a first server computer provides a first virtual machine activated with use of a master image to a first terminal, stop, when a predetermined timing, the first virtual machine, transmit, when the master image is not stored at a second site, transmit, information on the master image to the second site, transmit, to a second management computer, an instruction to generate a copy of the master image, transmit, to a second server computer, an instruction to provide the second virtual machine activated with use of the copy of master image to a second terminal, and delete the master image from the first storage apparatus when a period of time elapsed since a last use of the master image by the first virtual machine at the first site exceeds a predetermined period of time.

### BACKGROUND

This invention relates to a virtualization technology for providing a client computer with a desktop remotely.

As an example of a technology for providing each user of a client computer with a remote desktop, there is known Japanese Patent Application Laid-open No. 2011-210151. In Japanese Patent Application Laid-open No. 2011-210151, there is disclosed a technology for migrating a guest OS between a plurality of physical servers without using a shared storage and with use of an existing live migration technology. In order to migrate the guest OS, images of the same guest OS are provided in advance to respective storage apparatus to which two servers of a transfer source server and a transfer destination server refer. When each of the guest OSs is to be migrated, memory data and a CPU register that are used by the guest OS are copied to migrate the guest OS. In addition, on the guest OS, data to be written into a volume managed by the guest OS is redirected and cached into a memory in order to prohibit writing of data into the volume, to thereby inhibit writing of data into image data of the guest OS and updating of the image data.

### SUMMARY

However, the above-mentioned related art has the following problem. Specifically, the transfer source server and the transfer destination server both need to hold the copy of the image of the guest OS (master image), and hence an amount of data to be stored in the storage apparatus increases. This situation becomes more conspicuous when there are a plurality of master images.

This invention has been made in view of the above-mentioned problem, and an object thereof is to reduce a size of a storage apparatus for storing an image of an OS or a copy of the image.

A representative aspect of this invention is as follows. A computer system, comprising: a first site comprising a first storage apparatus, a first server computer for providing a first virtual machine, a first terminal coupled to the first server computer to use the first virtual machine, and a first management computer for managing the first storage apparatus, the first server computer, and the first terminal; a second site comprising a second storage apparatus, a second server computer for providing a second virtual machine, a second terminal coupled to the second server computer to use the second virtual machine, and a second management computer for managing the second storage apparatus, the second server computer, and the second terminal; and a network for coupling the first site and the second site to each other, the first storage apparatus being configured to store a first master image including an OS and an application, the first server computer being configured to provide the first virtual machine activated with use of the first master image to the first terminal based on an instruction issued from the first management computer, the first management computer being configured to monitor first user information for managing information on a user who uses the first virtual machine from the first terminal, stop, when a predetermined timing at which the user is to transfer to the second site arrives, the first virtual machine and then inquire of the second management computer whether or not the first master image is stored at the second site, transmit, when the first master image is not stored at the second site, information on the first master image to the second site, transmit, to the second management computer, an instruction to generate a copy of the first master image and store the generated copy in the second storage apparatus, transmit, to the second server computer, an instruction to provide the second virtual machine activated with use of the copy of the first master image to the second terminal, and delete the first master image from the first storage apparatus when a period of time elapsed since a last use of the first master image by the first virtual machine at the first site exceeds a predetermined period of time.

According to one embodiment of this invention, it is possible to reduce the size of the storage apparatus for storing the image including the OS or the copy of the image.

### BRIEF DESCRIPTION OF THE DRAWINGS

FIG. 1 shows a first embodiment of this invention, and is a block diagram illustrating an example of a computer system to which this invention is applied.

FIG. 2 shows the first embodiment of this invention, and is a block diagram illustrating an example of a terminal management server.

FIG. 3 shows the first embodiment of this invention, and is a block diagram illustrating an example of a terminal server.

FIG. 4 shows the first embodiment of this invention, and is a diagram showing an example of a master image management table.

FIG. 5 shows the first embodiment of this invention, and is a diagram showing an example of a user information management table.

FIG. 6 shows the first embodiment of this invention, and is a diagram showing an example of a site-by-site master management table.

FIG. 7 shows the first embodiment of this invention, and is a diagram showing an example of a site-by-site differential data management table.

FIG. 8 shows the first embodiment of this invention, and is a diagram showing an example of a schedule management table.

FIG. 9 shows the first embodiment of this invention, and is a flow chart illustrating an example of a new user creation program.

FIG. 10 shows the first embodiment of this invention, and is a flow chart illustrating an example of a VM migration program.

FIG. 11 shows the first embodiment of this invention, and is a flow chart illustrating an example of processing of copying the master image.

FIG. 12 shows the first embodiment of this invention, and is a flow chart illustrating an example of processing of copying the differential data.

FIG. 13 shows the first embodiment of this invention, and is a flow chart illustrating an example of copy source differential data deletion processing.

FIG. 14 shows the first embodiment of this invention, and is a flow chart illustrating an example of a master switching program.

FIG. 15 shows the first embodiment of this invention, and is a flow chart illustrating an example of a master image deletion program.

FIG. 16 shows the first embodiment of this invention, and is a flow chart illustrating an example of a VM allocation program.

FIG. 17 shows the first embodiment of this invention, and is a flow chart illustrating an example of a VM deallocation program.

FIG. 18 shows the first embodiment of this invention, and is a flow chart illustrating an example of a user deletion program.

FIG. 19 shows a first embodiment of this invention, and is a flow chart illustrating an example of differential data deletion necessity determination processing.

FIG. 20 shows a second embodiment of this invention, and is a flow chart illustrating an example of a master image deletion program.

### DETAILED DESCRIPTION OF THE PREFERRED EMBODIMENTS

Now, a description is given of embodiments of this invention with reference to the attached drawings.

It should be noted that, in the following description, although pieces of information of this invention are described by using such expressions as “aaa table”, “aaa list”, “aaa DB”, and “aaa queue” in some cases, those pieces of information may be expressed by in other forms than such data structures as a table, a list, a database (DB), a queue, and the like if necessary. Therefore, “aaa table”, “aaa list”, “aaa DB”, “aaa queue”, and the like are sometimes referred to as “aaa information” in order to show that those pieces of information are independent of their data structures.

In addition, although such expressions as “identification information”, “identifier”, “name”, and “ID” are used in some cases in order to describe details of each piece of information, those expressions are interchangeable.

In the following description, although a description is given by using “program” as a subject in some cases, the program is executed by a processor to perform defined processing while using a memory and a communication port (communication control device). Therefore, a description may be given by using “processor” as a subject. Further, processing disclosed while a program is used as a subject may also be interpreted as processing performed by a computer such as a management server or an information processing apparatus. Further, a part or all of a program may also be implemented by dedicated hardware.

Further, various programs may also be installed onto each computer by a program distribution server or a computer-readable non-transitory storage medium. In this case, the program distribution server includes a CPU and a storage resource, and further, the storage resource includes a distribution program and a program to be distributed. The distribution program is executed by the CPU of the program distribution server, which distributes the program to be distributed to other computers.

### First Embodiment

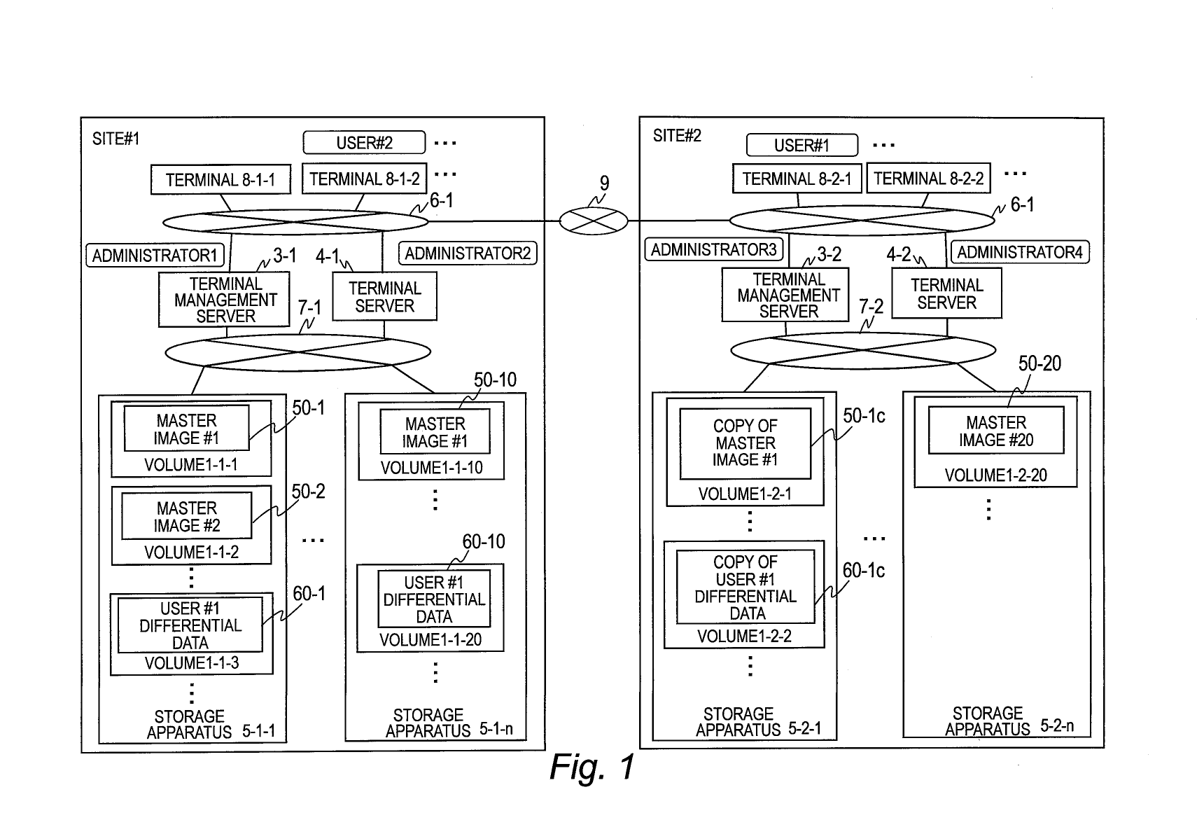

FIG. 1 is a block diagram illustrating an example of a computer system to which this invention is applied. In FIG. 1, the computer system includes a site #1 and a site #2, which are each coupled to a network 9.

The site #1 includes terminals 8-1-1 and 8-1-2, which are each used by a user, a terminal server 4-1 for providing a work environment (virtual desktop environment) of each user to each of the terminals 8-1-1 and 8-1-2 with use of a virtual machine, a terminal management server 3-1 for managing master images 50-1 to 50-20 and pieces of differential data 60-1 to 60-10 for building work environments of respective users, storage apparatus 5-1-1 to 5-1-n for storing the master images 50-1 to 50-20 and the pieces of differential data 60-1 to 60-10, a network 6-1 for coupling the terminals 8-1-1 and 8-1-2 to the terminal server 4-1 and the terminal management server 3-1, a network 7-1 for coupling the terminal management server 3-1 and the terminal server 4-1 to the storage apparatus 5-1-1 to 5-1-n. It should be noted that the network 6-1 is coupled via the network 9 to a network 6-2 of the site #2.

The configuration of the site #1 is similar to that of the site #2. For example, the terminals of the site #1 are each represented by a reference symbol 8-1 and the terminals of the site #2 are each represented by a reference symbol 8-2, and the terminals are collectively represented by a reference symbol 8. Further, the individual terminals are each represented by a reference symbol 8-i-n. As used herein, a suffix i is an identifier of each of the sites (in FIG. 1, #1 and #2), and a suffix n is a symbol for identifying each terminal. Moreover, the terminals are collectively represented by a reference symbol 8 without a suffix. The same holds true for other components. Specifically, the components are collectively represented by a reference symbol x without a suffix, and the individual components are each represented by a reference symbol x-i-n.

In addition, the network 9 includes a wide area network (WAN) and others, the network 6 includes a local area network (LAN) and others, and the network 7 includes a storage area network (SAN) and others.

The master image 50 is a boot image including an OS and an application. The differential data 60 is data generated or updated by each user with use of an OS or application. For example, a plurality of users belonging to the same organization share one master image 50 among the plurality of users, and data generated or updated by each of the users with use of the OS or application is held by each user as the differential data 60. In a first embodiment of this invention, the original master image is represented by a master image 50-i, and a copy of the master image 50-i is represented by a copy of master image 50-ic. It should be noted that i represents a suffix indicating each of the individual master images. The same holds true for the differential data 60. Specifically, the original differential data is represented by differential data 60-i, and a copy of the differential data 60-i is represented by a copy of differential data 60-ic.

In addition, the master images 50 and the pieces of differential data 60 are each stored in one of volumes 1-1-1 to 1-2-20, which are set within the storage apparatus 5.

In the computer system described above, the terminal management server 3 provides in advance, to the site to be used by the user, the master image 50 or the copy of master image 50-ic and the differential data 60 or the copy of differential data 60-ic. Accordingly, when the user is to transfer from one site to another to use the terminal 8, the user sets in advance, to a scheduler 106, the site to which the user is to transfer and a scheduled date of his/her transfer.

When the user starts using the terminal 8 at the site to which the user has transferred, with use of the copy of master image 50-ic and the copy of differential data 60-ic that are provided in advance, the terminal server 4 can execute a virtual machine 113, to thereby provide a virtual desktop environment that has been previously used at the site from which the user has transferred. For example, by making an access to the virtual machine 113 of the terminal server 4 with use of remote desktop connection or the like through the terminal 8, the user #1 of FIG. 1 can continue the work under the virtual desktop environment that has been previously used even when the user has transferred from the site #1 to the site #2.

Then, when the user #1 returns to the site #1 from which the user #1 has transferred, the copy of master image 50-ic and copy of differential data 60-ic remaining at the site #2 are no longer in use. A terminal management server 3-2 of the site #2 deletes the copy of master image 50-ic and the copy of differential data 60-ic that have not been used over a predetermined period of time. In this way, it is possible to prevent the copy of master image 50-ic and the copy of differential data 60-ic that are no longer in use after the transfer of the user #1 from remaining in the storage apparatus 5, thereby reducing a size of the storage apparatus 5 that is used in a wasteful manner.

It should be noted that, although the computer system includes two sites in the example of FIG. 1, the number of sites may be set arbitrarily. The same holds true for the number of the terminals 8 and the number of the storage apparatus 5 of each site, and those numbers may be set arbitrarily.

Further, although the terminal 8 is coupled in advance to the network 6 in the example described above, the user may alternatively carry a mobile terminal and couple the mobile terminal to the network 6 at a predetermined site.

The configuration of the site #1 is similar to that of the site #2, and hence in the following, descriptions are given of the apparatus of the site #1, and descriptions of the apparatus of the site #2 are omitted.

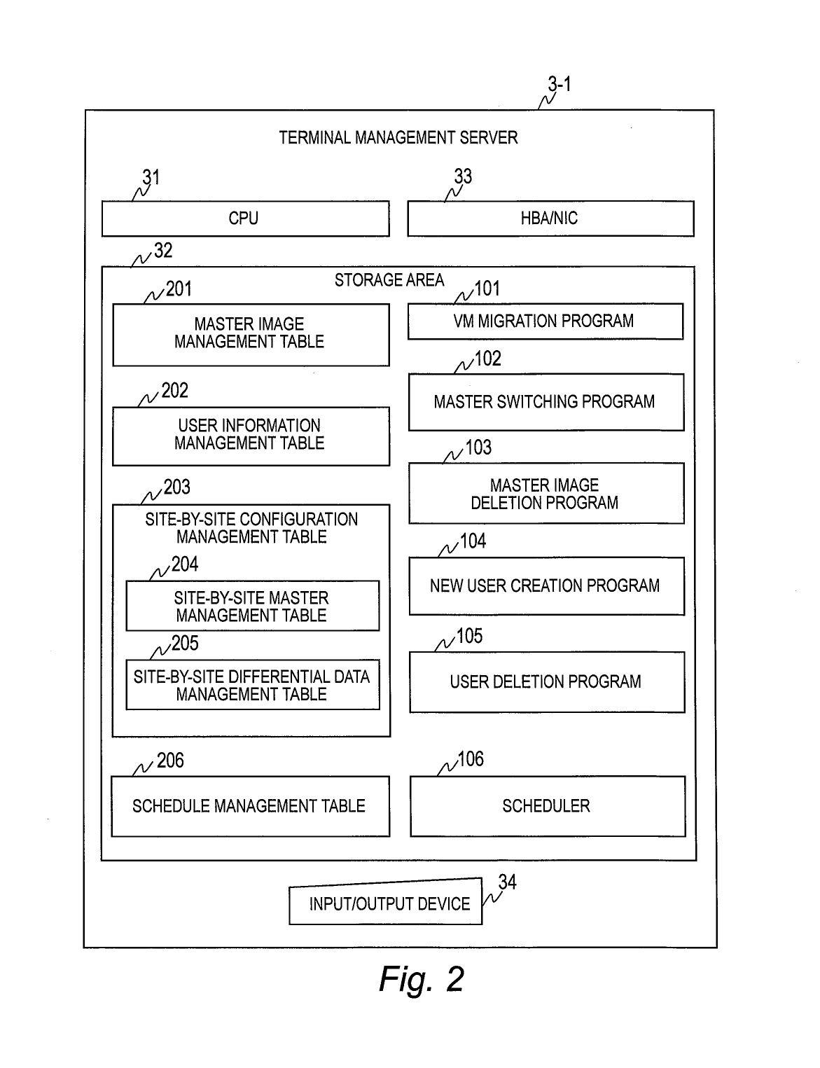

FIG. 2 is a block diagram illustrating an example of the terminal management server. The terminal management server 3-1 includes a CPU 31 for performing arithmetic processing, a storage area 32 including a memory and others for storing data and programs, a host bus adapter (HBA)/network interface card (NIC) 33 to be used to communicate to/from the terminal 8 and the storage apparatus 5, and an input/output device 34 for inputting/outputting data and instructions. The input/output device 34 includes an input device such as a mouse and a keyboard and an output device such as a display.

On the storage area 32 of the terminal management server 3-1, management of the master image 50 and differential data 60 to be used by each user, copying of the master image 50 and the differential data 60 when the user transfers from one site to another, and other such control are performed.

Stored in the storage area 32 of the terminal management server 3-1 are tables and programs for managing a transfer schedule of the user and the master image 50 and differential data 60 used by the user. The tables include a master image management table 201 for managing a use status of the master image 50 and the administrator or creator thereof, a user information management table 202 for managing, for each user, the master image 50 and differential data 60 used by the user, a site-by-site configuration management table 203 for managing information stored in each site, and a schedule management table 206. It should be noted that the site-by-site configuration management table 203 includes a site-by-site master management table 204 and a site-by-site differential data management table 205. Details of the respective tables are described later.

The programs include a VM migration program 101 for copying the master image 50 and the differential data 60 when the user transfers from one site to another, a master switching program 102 for modifying or updating the OS and application of the master image 50, a master image deletion program 103 for deleting the master image 50 or the copy of master image 50-ic that has not been used over the predetermined period of time, a new user creation program 104 for allocating the master image 50 and the differential data 60 to a new user, a user deletion program 105 for deleting the user and the master image 50 and differential data 60, and the scheduler 106 for managing the user's schedule of the transfer from one site to another. Details of the respective programs are described later.

The respective programs are stored in the storage apparatus 5, and loaded onto the storage area 32 to be executed by the CPU 31. Information, such as the programs and tables, for implementing respective functions of the terminal management server 3 can be stored in the storage apparatus 5 as well as a storage device such as a non-volatile semiconductor memory, a hard disk drive, and a solid state drive (SSD), or a computer-readable non-transitory data storage medium such as an IC card, an SD card, and a DVD.

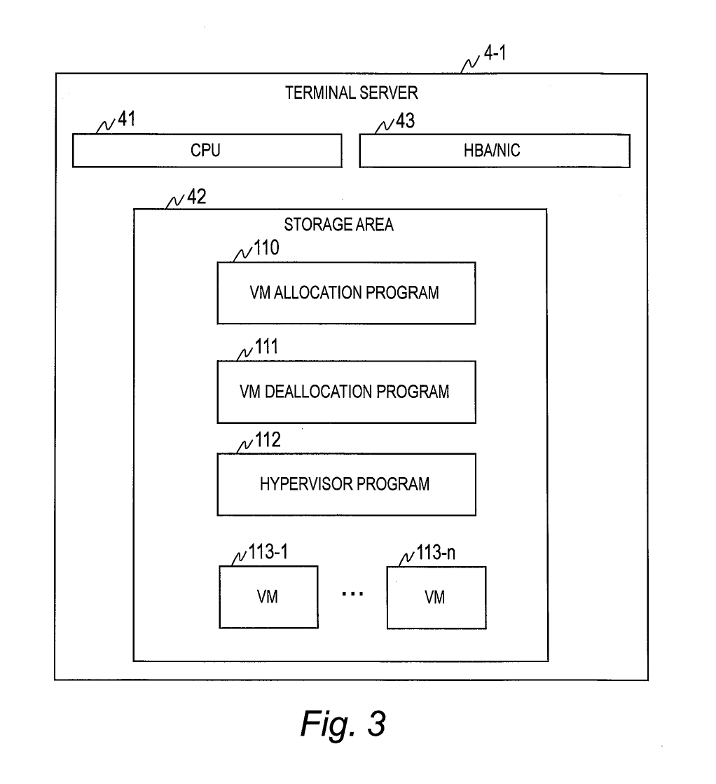

FIG. 3 is a block diagram illustrating an example of the terminal server 4-1. The terminal server 4-1 includes a CPU 41 for performing arithmetic processing, a storage area 42 including a memory and others for storing data and programs, and an HBA/NIC 43 to be used to communicate to/from the terminal 8 and the storage apparatus 5.

Stored in the storage area 42 of the terminal server 4-1 are a hypervisor program 112 for dividing computer resources to execute a plurality of virtual machines (VMs), a VM deallocation program 111, and a VM allocation program 110.

The respective programs are stored in the storage apparatus 5, and loaded onto the storage area 42 to be executed by the CPU 41. Information, such as the programs and tables, for implementing respective functions of the terminal server 4 can be stored in the storage apparatus 5 as well as a storage device such as a non-volatile semiconductor memory, a hard disk drive, and a solid state drive (SSD), or a computer-readable non-transitory data storage medium such as an IC card, an SD card, and a DVD. Details of the respective programs are described later.

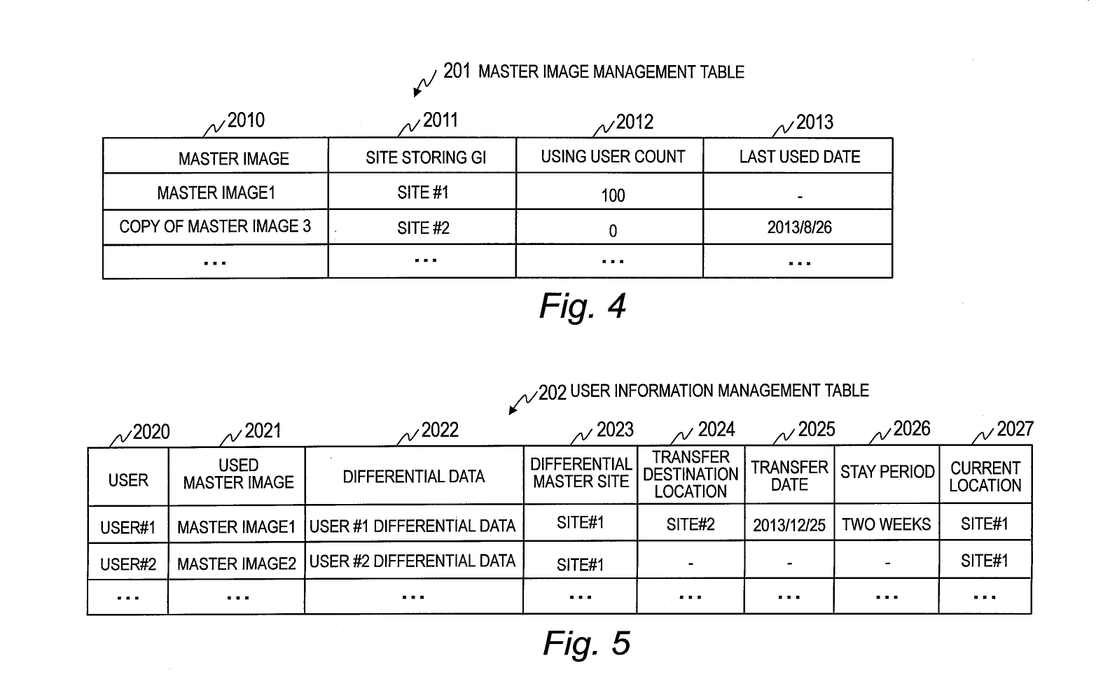

FIG. 4 is a diagram showing an example of the master image management table 201. The master image management table 201 includes, for each record, a master image 2010 for storing the identifier of the master image 50, a site 2011 for storing a site at which the golden image (“GI” in FIG. 4) is stored, a using user count 2012 for storing a count of users who are using the associated master image 50, and a last used date 2013 for storing a date on which the associated master image 50 is used last.

As used herein, the golden image refers to the master image 50 that has been created first, and is a boot image including the OS and application of a new virtual desktop.

FIG. 5 is a diagram showing an example of the user information management table 202. The user information management table 202 includes, for each record, a user 2020 for storing the identifier of the user, a used master image 2021 for storing the identifier of the master image 50 used by the associated user, a differential data 2022 for storing the identifier of the differential data 60 used by the associated user, a differential master site 2023 for storing the identifier of the site that has first created the associated differential data 60, a transfer destination location 2024 for storing the identifier of the site to which the associated user is scheduled to transfer, a transfer date 2025 for storing a date on which the associated user is scheduled to transfer, a stay period 2026 for storing a period of time during which the user is to stay at the transfer destination location, and a current location 2027 for storing the identifier of the site to which the associated user currently belongs.

The transfer destination location 2024, the transfer date 2025, and the stay period 2026 are acquired from the schedule management table 206 to be described later by the terminal management server 3 at a predetermined timing. It should be noted that, when the user uses the scheduler 106 to update the schedule management table 206 and the transfer destination is thus determined, the scheduler 106 may write the values of the schedule management table 206 into the user information management table 202.

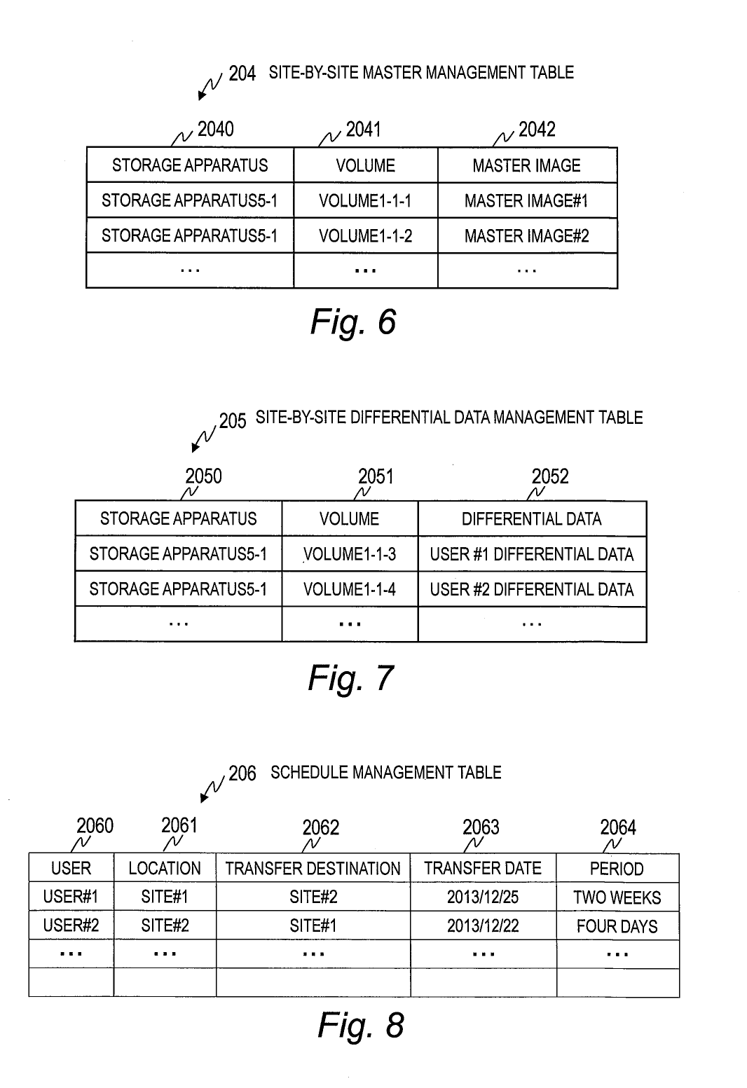

FIG. 6 is a diagram showing an example of the site-by-site master management table 204. The site-by-site master management table 204 includes, for each record, a storage apparatus 2040 for storing the identifier of the storage apparatus 5 in which the associated master image 50 is stored, a volume 2041 for storing the identifier of the volume in which the associated master image 50 is stored, and a master image 2042 for storing the identifier of the master image 50 stored in the associated volume.

With the site-by-site master management table 204, the identifier of the master image 50 and the identifier of the volume are associated with each other.

FIG. 7 is a diagram showing an example of the site-by-site differential data management table 205. The site-by-site differential data management table 205 includes, for each record, a storage apparatus 2050 for storing the identifier of the storage apparatus 5 in which the associated differential data 60 is stored, a volume 2051 for storing the identifier of the volume in which the associated differential data 60 is stored, and a differential data 2052 for storing the identifier of the differential data 60 stored in the associated volume.

With the site-by-site differential data management table 205, the identifier of the differential data 60 and the identifier of the volume are associated with each other.

FIG. 8 is a diagram showing an example of the schedule management table 206. The schedule management table 206 holds the schedule of the user input from the terminal 8 through the scheduler 106.

The schedule management table 206 includes, for each record, a user 2060 for storing the identifier of the user, a location 2061 for storing the identifier of the site at which the associated user uses the terminal 8, a transfer destination 2062 for storing the identifier of the site to which the associated user is scheduled to transfer, a transfer date 2063 for storing a scheduled date of the transfer, and a period 2064 for storing a period of time during which the user is to stay at the transfer destination 2062.

Each user operates the terminal 8 to activate the scheduler 106, and sets his/her own schedule. The scheduler 106 uses information received from the terminal 8 to update the user information management table 202. It should be noted that, when there is no transfer schedule, the transfer destination location 2024, transfer date 2025, and stay period 2026 of the associated user are blank.

The schedule management table 206 holds, for each user, the schedule of the user indicating a specific date on which the user is to use the terminal 8 and a specific site at which the user is to use the terminal 8, and is managed by the scheduler 106.

When the user transfers from one site to another after updating the schedule management table 206, the scheduler 106 updates the records of the user information management table 202 that are associated with this user. Specifically, based on information updated on the schedule management table 206, the scheduler 106 updates the transfer destination location 2024, transfer date 2025, stay period 2026, and current location 2027 of the user information management table 202.

In this way, the VM migration program 101 can acquire the transfer schedule of the user by referring to the user information management table 202.

It should be noted that the above-mentioned master image management table 201 and schedule management table 206 held by the terminal management server 3-1 of the site #1 are synchronized with the respective management tables held by the terminal management server 3-2 of the other site #2 at predetermined cycles (for example, every hour). In addition, the site-by-site configuration management table 203 is information unique to each site.

In the following, a description is given of an example of processing executed at the sites #1 and #2 with reference to flow charts.

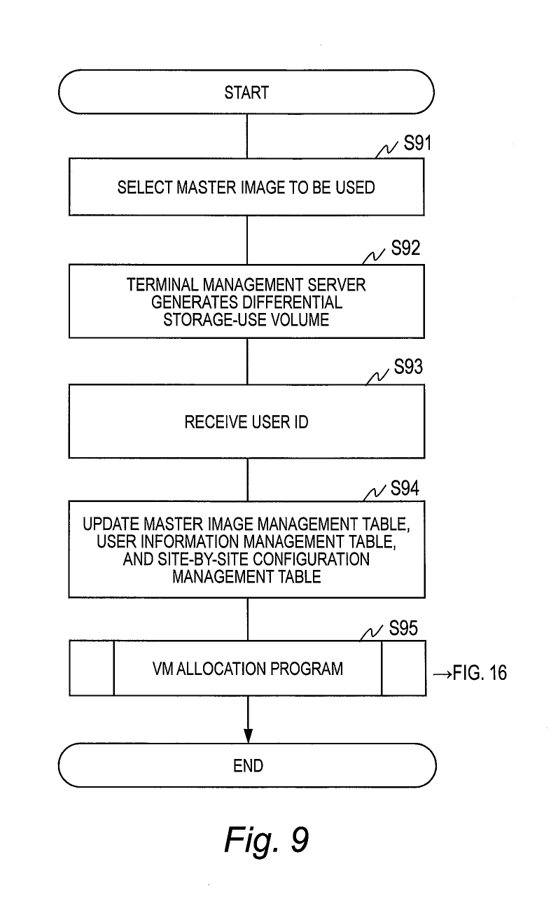

FIG. 9 is a flow chart illustrating an example of the new user creation program 104. The terminal management server 3-1 starts executing this processing when the administrator or other such person of the site inputs a predetermined instruction through use of the input/output device 34 of the terminal management server 3-1 in order to register a new user.

The terminal management server 3-1 refers to the storage apparatus 5 via the network 7-1 to select the master image 50 to be used by the user who is to be registered in response to the instruction of the administrator (S91).

Next, the terminal management server 3-1 generates the volume (differential storage-use volume) for storing the differential data 60 in the storage apparatus 5-1 in response to the instruction of the administrator, and acquires the identifier of the generated volume (S92). The terminal management server 3-1 receives the identifier of the user from the input/output device 34 (S93).

The terminal management server 3-1 generates or allocates, to the received user's identifier, the volumes for storing the master image 50 selected in Step S91 and the differential data 60 generated in Step S92, and updates the respective management tables (S94).

To be specific, the terminal management server 3-1 adds a new record to the user information management table 202 of FIG. 5, stores the user's identifier received in Step S93 in the user 2020, stores the identifier of the master image 50 selected in Step S91 in the used master image 2021, and stores the identifier of the volume for storing the differential data 60 generated in Step S92 in the differential data 2022.

Currently, the terminal management server 3-1 has generated the volume for storing the differential data 60 in the storage apparatus 5-1 at the site #1, and hence the terminal management server 3-1 stores the identifier of the volume acquired in Step S92 in the differential data 2022 of the user information management table 202 to be a master of the volume of the differential data 60, and sets the site #1 as the current location 2027, to thereby update the user information management table 202.

Next, the terminal management server 3-1 has selected in Step S91 the master image 50 to be used, and hence the terminal management server 3-1 increments the using user count 2012 of the record of the master image management table 201 whose master image 2010 matches the identifier of the selected master image 50.

Further, the terminal management server 3-1 stores the identifier of the volume for storing the differential data 60 generated in Step S92 in the volume 2051 of the site-by-site differential data management table 205, and stores the identifier of the differential data 60 in the differential data 2052.

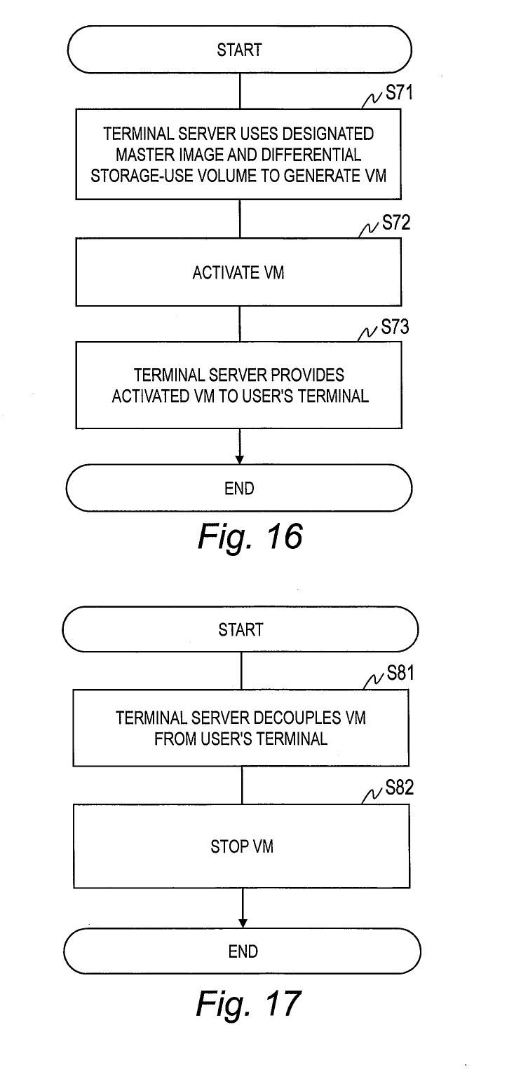

Next, in Step S95, the terminal management server 3-1 controls the terminal server 4-1 to execute the VM allocation program 110, and to run the virtual machine 113 of the user generated by the VM allocation program 110. FIG. 16 illustrates the VM allocation program 110.

FIG. 16 is a flow chart illustrating an example of the VM allocation program 110. The VM allocation program 110 is executed when the terminal server 4-1 receives a request to allocate the virtual machine (VM) 113. The allocation request for the virtual machine 113 includes the identifier of the user, the identifier of the master image 50, and the identifier of the differential data 60.

The terminal server 4-1 generates the virtual machine (VM) 113 based on the received identifiers of the user, the master image 50, and the differential data 60. To be specific, the terminal server 4-1 instructs its hypervisor program 112 to allocate the computer resources of the terminal server 4-1 to generate the virtual machine 113 (S71).

Next, the terminal server 4-1 instructs the hypervisor program 112 to read the master image 50 corresponding to the identifier from the volume of the storage apparatus 5-1 and activate the virtual machine 113 (S72). To be specific, the hypervisor program 112 inquires the volume of the master image 50 corresponding to the identifier included in the instruction from the terminal management server 3-1. The terminal management server 3-1 refers to the site-by-site master management table 204 to search for the record whose master image 2042 matches the above-mentioned identifier, and responds to the terminal server 4-1 with the storage apparatus 2040 and volume 2041 of the retrieved record. The terminal server 4-1 uses the storage apparatus 2040 and volume 2041 received from the terminal management server 3-1 to read the master image 50, and activates the virtual machine 113. At this time, the hypervisor program 112 inquires the volume of the differential data 60 corresponding to the identifier included in the instruction from the terminal management server 3-1. The terminal management server 3-1 refers to the site-by-site differential data management table 205 to search for the record whose differential data 2052 matches the above-mentioned identifier, and responds to the terminal server 4-1 with the storage apparatus 2050 and volume 2051 of the retrieved record. The terminal server 4-1 uses the storage apparatus 2050 and volume 2051 received from the terminal management server 3-1 to read the differential data 60, and allocates the read differential data 60 to the virtual machine 113. The terminal server 4-1 provides the virtual machine 113 to the terminal 8 used by the user as a virtual desktop.

It should be noted that the allocation request for the virtual machine 113 may include the identifier of the user. In this case, the terminal server 4-1 inquires the storage apparatus 5 and volume storing the master image 50 and differential data 60 from the terminal management server 3-1 with use of the identifier of the user. The terminal management server 3-1 uses the received identifier of the user to refer to the user information management table 202, acquires the used master image 2021 and differential data 2022 of the retrieved record, and responds with the storage apparatus 5 and volumes with reference to the site-by-site master management table 204 and the site-by-site differential data management table 205 in a manner similar to the one described above.

Through the processing described above, the virtual machine 113, in which the master image 50 and the differential data 60 for storing data created by a new user are allocated to the new user, starts running. When the new user operates the terminal 8 of the site #1 to couple the terminal 8 to the terminal server 4-1, the new user can use the virtual machine 113, which has already been activated with use of the master image 50 of the new user and includes the volume for storing the differential data 60, as the virtual desktop.

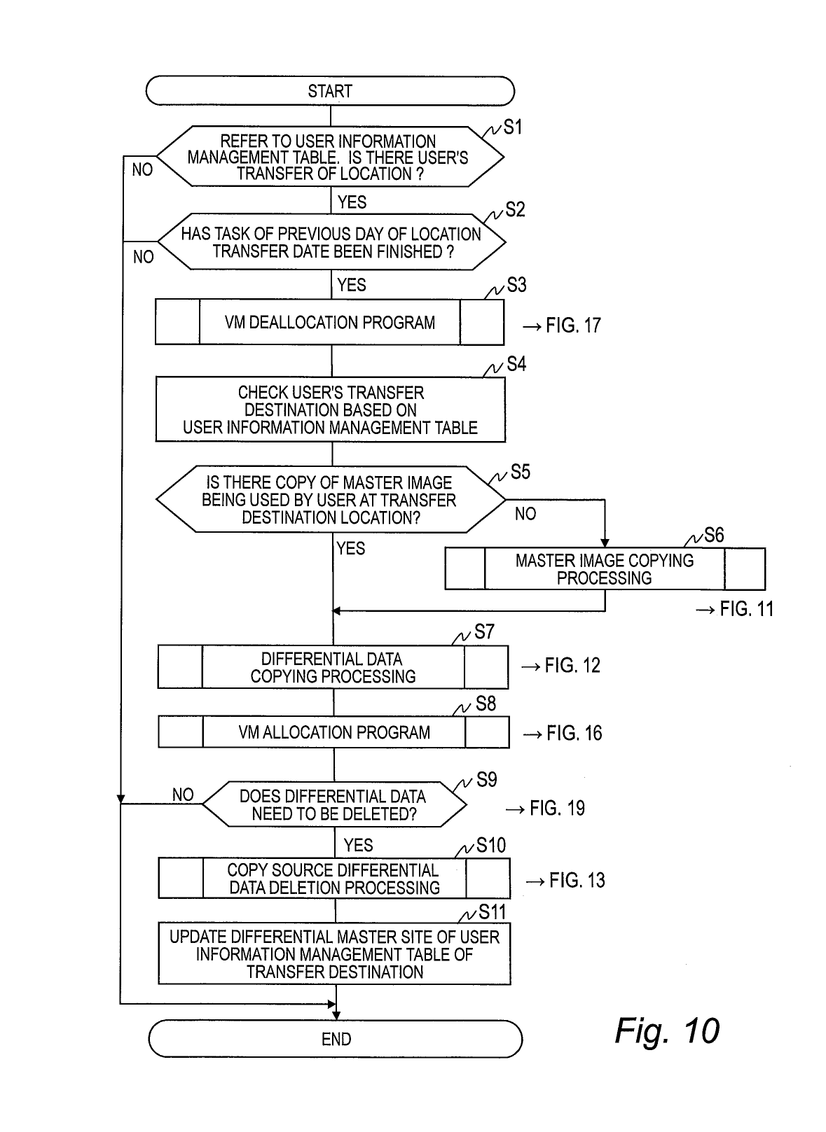

FIG. 10 is a flow chart illustrating an example of the VM migration program 101. This processing is executed by the terminal management server 3-1 at predetermined cycles, for example, at a predetermined time (at 23:00 or the like) every day. In an example to be described below, the user #1 who has coupled the terminal 8 at the site #1 is to transfer to the site #2. It should be noted that the master image 50-1 and differential data 60-1 used by the user #1 are stored in the storage apparatus 5-1-1.

The terminal management server 3-1 monitors the user information management table 202 to determine whether or not there is a user #1 who is to transfer his/her location from the current site #1 (S1). The terminal management server 3-1 refers to the user information management table 202, and when there is a record in which a value is set as the transfer destination location 2024 and the current location 2027 is the site #1, the terminal management server 3-1 selects the record and determines that there is a transfer schedule, and proceeds to Step S2.

On the other hand, when there is no record in which the current location 2027 is the site #1 and the value is set as the transfer destination location 2024, the terminal management server 3-1 determines that there is no schedule of the transfer from the site #1, and brings the processing to an end.

In Step S2, the terminal management server 3-1 refers to the selected records of the user information management table 202 having the transfer schedule to select the record whose transfer date 2025 is the next day among those records. The terminal management server 3-1 determines whether or not the user #1 who is to transfer to the other site #2 the next day has finished the use (task) of the virtual machine 113. This determination is performed as follows. Specifically, the terminal management server 3-1 inquires of the terminal server 4-1 whether or not there are a terminal 8 and a virtual machine 113 that are coupled to each other with the identifier of the user #1 who is scheduled to transfer. The terminal server 4-1 acquires the identifier of the user #1 included in the inquiry about the use, which is issued from the terminal management server 3-1. When the identifiers of the users of the terminals 8 coupled to the terminal server 4-1 currently include the identifier of the user #1, the terminal server 4-1 responds to the terminal management server 3-1 with the fact that the user #1 is using the virtual machine 113. On the other hand, when the identifiers of the users of the terminals 8 coupled to the terminal server 4-1 do not include the identifier of the user #1, the terminal server 4-1 responds to the terminal management server 3-1 with the fact that the user #1 has finished using the virtual machine 113. It should be noted that the terminal server 4-1 may determine whether or not the user #1 is using the virtual machine 113 based on the connection (login) state of the terminal 8, or determine whether or not the user #1 is using the virtual machine 113 based on the identifier of the user #1 coupled to the virtual machine 113.

When the user #1 who is scheduled to transfer has finished using the virtual machine 113, the terminal management server 3-1 proceeds to Step S3. On the other hand, when the user #1 who is scheduled to transfer is using the virtual machine 113, the terminal management server 3-1 brings the processing to an end.

It should be noted that the processing described above only needs to be repeatedly performed on every user who is to transfer to another site the next day. Further, when the user #1 who is scheduled to transfer is using the virtual machine 113, the terminal management server 3-1 may inquire of the terminal 8 or virtual machine 113 being used by the user #1 whether or not migration processing is to be performed. In this case, when the user #1 accepts the migration processing, the terminal management server 3-1 proceeds to the processing of Step S3.

In Step S3, the terminal management server 3-1 controls the terminal server 4-1 to execute the VM deallocation program 111 of deallocating the virtual machine 113 allocated to the user #1 who is scheduled to transfer.

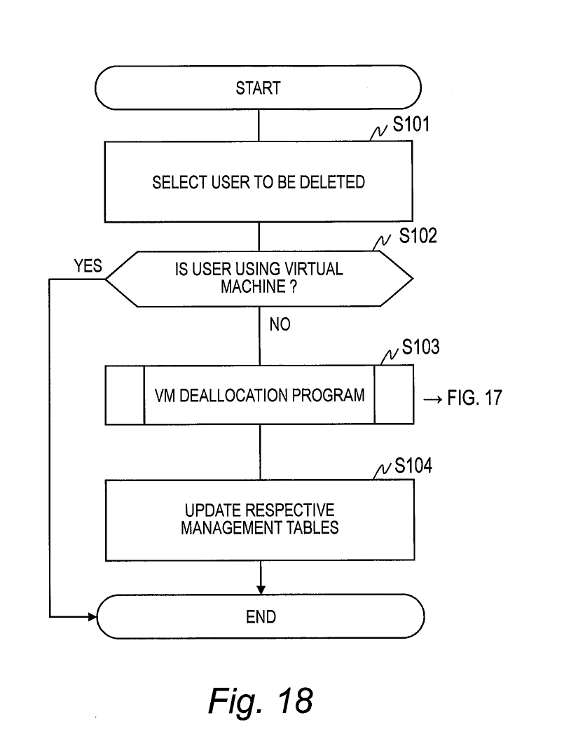

FIG. 17 is a flow chart illustrating an example of the VM deallocation program 111. In order to deallocate the virtual machine 113 allocated to the user #1 who is scheduled to transfer to the site #2 the next day, the terminal management server 3-1 issues to the terminal server 4-1 the identifier of the user #1 and a request to deallocate the virtual machine 113 (deallocation request). When receiving the deallocation request for the virtual machine 113, the terminal server 4-1 activates the VM deallocation program 111.

The terminal server 4-1 decouples the virtual machine 113 allocated to the user #1 having the received identifier from the terminal 8 (S81). In this way, the terminal server 4-1 finishes providing the virtual machine 113 to the user #1 who is scheduled to transfer the next day. It should be noted that the terminal server 4-1 includes a table (not shown) for holding an association relationship between the identifier of the user and the virtual machine 113.

Next, the terminal server 4-1 stops the virtual machine 113 that has been allocated to the user #1 (S82). The terminal server 4-1 deallocates the computer resources that have been allocated to the virtual machine 113 of the user #1. The terminal server 4-1 then transmits to the terminal management server 3-1 a notification that the deallocation of the virtual machine 113 of the user #1 has been completed. The notification of completion of deallocation of the virtual machine 113 includes the identifier of the user #1 to which the virtual machine 113 has been allocated.

Referring back to FIG. 10, in Step S4, the terminal management server 3-1 refers to the user information management table 202 to acquire the transfer destination location 2024 of the user 2020 who is scheduled to transfer. In this case, the transfer destination of the user #1 is a copy destination of the master image 50-1 and differential data 60-1 that have been used by the user #1. The terminal management server 3-1 inquires the terminal management server 3-2 of the transfer destination site #2 whether or not the copy of master image 50-1c used by the user #1 who is scheduled to transfer exists at the transfer destination site #2. The terminal management server 3-1 transmits the identifier of the master image 50 and a search request to the terminal management server 3-2 of the transfer destination site #2. The terminal management server 3-2 searches the master image 2042 of the site-by-site master management table 204 managed by the terminal management server 3-2 itself for the copy of master image 50-1c received in the search request, and responds to the terminal management server 3-1 with a search result. It should be noted that the terminal management server 3-2 only needs to respond with, as the search result, information indicating whether or not the copy of master image 50-1c whose identifier is included in the search request exists.

Next, in Step S5, when the search result obtained at the transfer destination site #2 indicates that the copy of master image 50-1c exists at the site #2, the terminal management server 3-1 proceeds to Step S7, and when the search result indicates that there is no copy of master image 50-1c at the transfer destination site #2, the terminal management server 3-1 proceeds to Step S6.

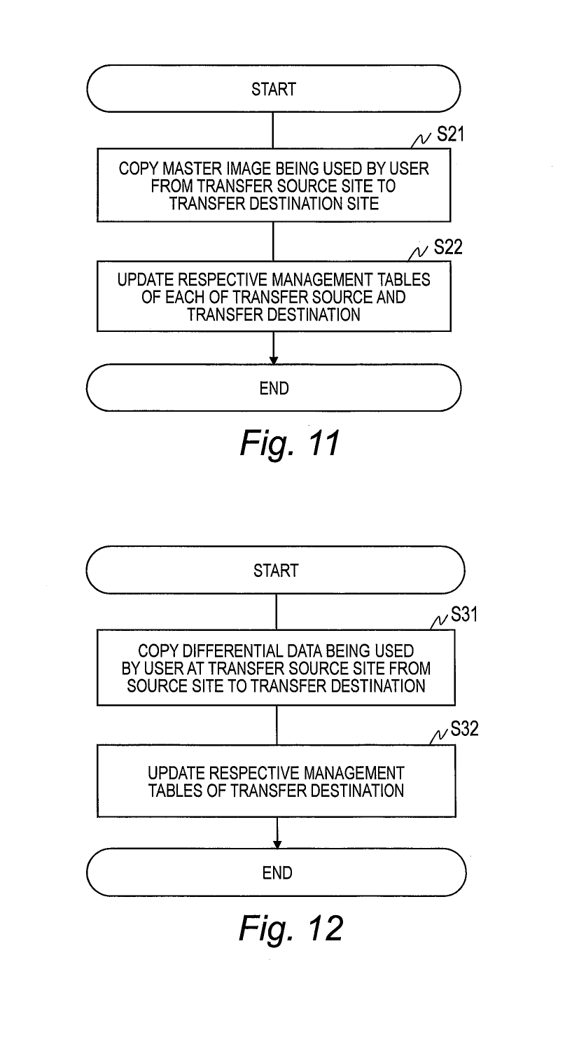

In Step S6, as illustrated in FIG. 11, the terminal management server 3-1 copies the master image 50 from the current site #1 (transfer source site) used by the user #1 to the terminal management server 3-2 of the site #2 as the transfer destination (transfer destination site). The terminal management server 3-2 of the site #2 then stores a new copy of master image 50-1c in the volume of the storage apparatus 5-2. It should be noted that the terminal management server 3-2 of the site #2 allocates an existing free volume or new volume of the storage apparatus 5-2 to the new copy of master image 50-1c and stores the new copy of master image 50-1c in the allocated volume.

FIG. 11 is a flow chart illustrating an example of processing of copying the master image 50. This processing is executed in Step S6 of FIG. 10.

The terminal management server 3-1 reads the master image 50 (master image #1) being used by the user #1, and transmits contents of the master image 50 to the terminal management server 3-2 of the transfer destination site #2. The terminal management server 3-2 generates the copy of master image 50-1c based on the contents of the master image (#1) received from the site #1, and stores the generated copy of master image 50-1c in the volume of the storage apparatus 5-2 (S21).

The terminal management server 3-1 and the terminal management server 3-2 update the respective management tables (S22). To be specific, the terminal management server 3-1 and the terminal management server 3-2 add new records to the master image management tables 201 of the respective sites, and set “Copy of Master Image 1”, “Site #1”, and “1” as the master image 2010, the site 2011 storing the GI, and the using user count 2012, respectively. In addition, the terminal management server 3-2 of the site #2 adds a new record to the site-by-site master management table 204, and sets the volume 2041 and storage apparatus 2040 that store the copy of master image 50-1c.

Through the processing described above, the copy of master image 50-1c used by the user #1 is provided in advance to the transfer destination site #2.

In Step S7 of FIG. 10, contents of the differential data 60-1 used by the user #1 are transmitted to the transfer destination site #2 to create a copy of the differential data 60-1. FIG. 12 illustrates this processing.

FIG. 12 is a flow chart illustrating an example of processing of copying the differential data. This processing is executed in Step S7 of FIG. 10.

The terminal management server 3-1 reads the differential data (user #1 differential data) 60-1 being used by the user #1, and transmits contents of the differential data 60 to the terminal management server 3-2 of the transfer destination site #2. The terminal management server 3-2 generates the copy of differential data 60-1c based on the information received from the site #1, and stores the generated copy of differential data 60-1c in the volume of the storage apparatus 5-2 (S31).

The terminal management server 3-2 updates the respective management tables (S32). To be specific, the terminal management server 3-2 of the site #2 adds a new record to the site-by-site differential data management table 205, and sets the volume 2051 and storage apparatus 2050 that store the copy of differential data 60-1c.

Through the processing described above, the copy of differential data 60-1c used by the user #1 is provided in advance to the transfer destination site #2.

In Step S8 of FIG. 10, the virtual machine 113 is allocated to the user #1 at the site #2. In this processing, the terminal server 4-2 of the site #2 is controlled to execute the flow chart described above with reference to FIG. 16.

The terminal management server 3-1 of the site #1 transmits to the terminal management server 3-2 of the site #2 a VM allocation request for allocating the virtual machine 113 to the user #1 who is scheduled to transfer the next day. The VM allocation request includes the identifier of the user #1, the identifier of the master image to be used (in this case, the copy of master image 50-1c), and the identifier of the differential data to be used (in this case, the copy of differential data 60-1c).

When receiving the VM allocation request, in a manner similar to the one described above with reference to FIG. 16, the terminal management server 3-2 of the site #2 controls the terminal server 4-2 to generate the virtual machine 113, activates the virtual machine 113 with use of the copy of master image 50-1c, and allocates the copy of differential data 60-1c to the activated virtual machine 113.

It should be noted that the terminal management server 3-1 of the site #1 may transmit to the terminal server 4-2 of the site #2 the VM allocation request for allocating the virtual machine 113 to the user #1 who is scheduled to transfer the next day.

In Step S9 of FIG. 10, the terminal management server 3-1 of the site #1 determines whether or not the original differential data 60-1 held at the site #1 needs to be deleted. This processing is described later.

When the differential data 60-1 of the site #1 needs to be deleted, the terminal management server 3-1 proceeds to Step S10, and when the differential data 60-1 of the site #1 does not need to be deleted, the terminal management server 3-1 proceeds to Step S11.

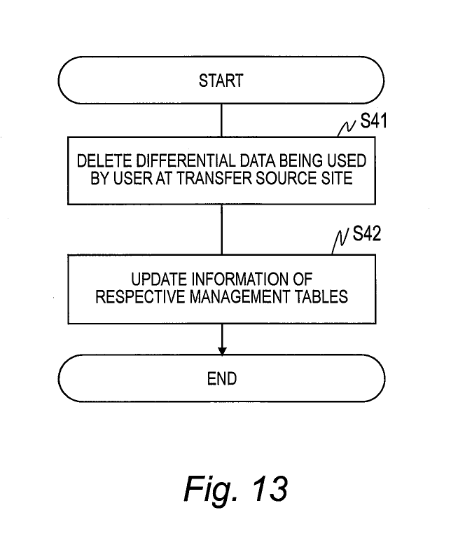

In Step S10, the terminal management server 3-1 deletes the original differential data 60-1 from the site #1 through processing of FIG. 13.

FIG. 13 is a flow chart illustrating an example of copy source differential data deletion processing. The terminal management server 3-1 deletes from the storage apparatus 5-1 the differential data 60-1 used by the user #1 who is scheduled to transfer (S41).

Next, the terminal management server 3-1 updates the respective management tables in response to the deletion of the differential data 60-1 (S42). To be specific, the terminal management server 3-1 deletes the record of the differential data 60-1 of the user #1 (“User #1 Differential Data” of FIG. 7) from the site-by-site differential data management table 205.

Next, the terminal management server 3-1 selects the record of the user information management table 202 corresponding to the user #1, and clears the field of the differential data 2022 of the selected record.

Next, in Step S11 of FIG. 10, the terminal management server 3-1 requests the terminal management server 3-2 of the transfer destination site #2 to update the differential master site 2023 of the user information management table 202 (Update Request 1). This update request includes the identifier of the user, the identifier of the differential data 60-1, and the transfer destination site #2 as the differential master site.

When receiving the update request for the user information management table 202, the terminal management server 3-2 of the site #2 acquires the identifier of the user, the identifier of the differential data 60-1, and the differential master site. The terminal management server 3-2 uses the identifier of the user to search the user information management table 202, and adds a new record when there is no corresponding record. The terminal management server 3-2 sets the identifier of the user, the identifier of the differential data 60-1, and the current site #2 as the user 2020, differential data 2022, and differential master site 2023 of the user information management table 202, respectively. When the differential data 60 is migrated from one site to another, the transfer destination site is changed to be a master site of the differential data 60.

Through the processing described above, on the previous day of the transfer date, the copy of master image 50-1c and the copy of differential data 60-1c are generated with respect to the master image 50 and differential data 60 of the user #1 at the transfer destination site #2, and the virtual machine 113 running on the copy of master image 50-1c is generated. Further, the site #2 is set as the location of the user #1 in the user information management table 202, and when the user #1 uses the terminal 8 at the site #2, the terminal server 4-2 can execute the virtual machine 113 under the same environment as that of the site #1 (the copy of master image 50-1c and the copy of differential data 60-1c) to provide the virtual desktop.

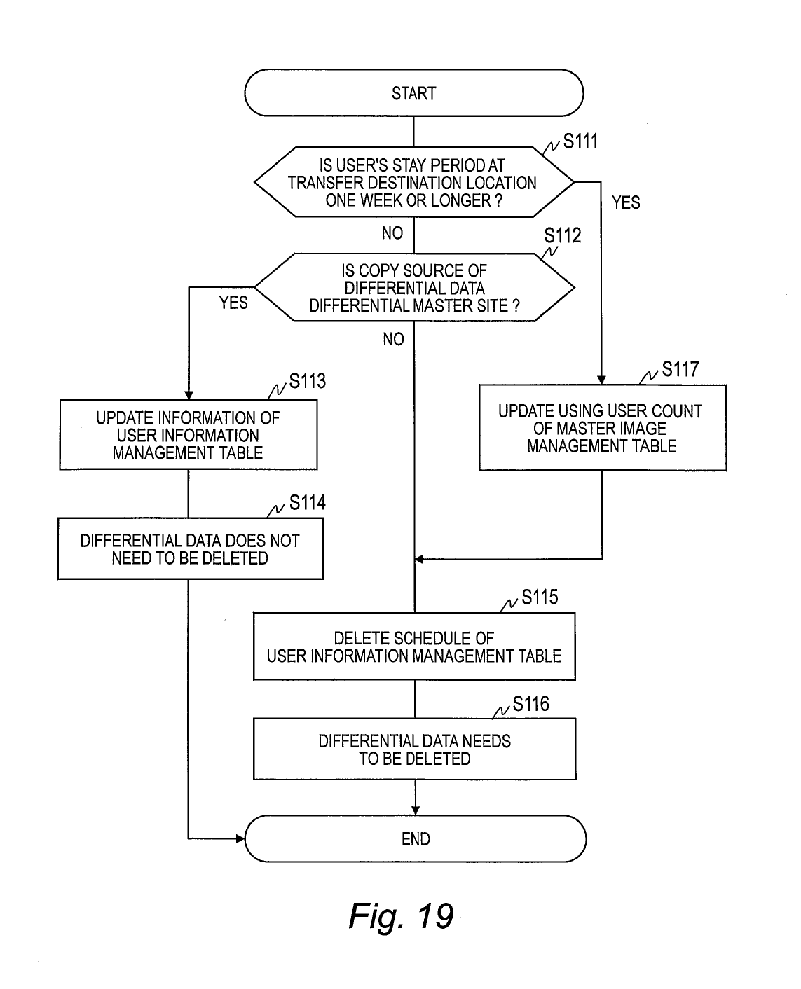

FIG. 19 is a flow chart illustrating an example of differential data deletion necessity determination processing. This processing is executed by the terminal management server 3-1 in Step S9 of FIG. 10.

The terminal management server 3-1 refers to the user information management table 202 to select the record of the user #1 who is scheduled to transfer, and acquires the stay period 2026 of the selected record. The terminal management server 3-1 determines whether or not the stay period 2026 is a predetermined period of time (for example, one week) or longer (S111). When the stay period 2026 is one week or longer, the terminal management server 3-1 proceeds to Step S117, and when the stay period 2026 is shorter than one week, the terminal management server 3-1 proceeds to Step S112.

In Step S117, the users of the master image 1 of the site #1 decreases by one when the user #1 stays at the site #2 for one week or longer, and hence the terminal management server 3-1 selects the record of the master image management table 201 corresponding to the master image 1 used by the user #1, and decrements the using user count 2012 of the selected record.

In Step S112, which is executed when the stay period is shorter than one week, the terminal management server 3-1 selects the record of the user information management table 202 whose user 2020 matches the user #1 who is scheduled to transfer, and determines whether or not the copy source of the differential data 60 matches the differential master site 2023. When the copy source of the differential data 60 matches the differential master site 2023, the terminal management server 3-1 proceeds to Step S113, and when the copy source of the differential data 60 does not match the differential master site 2023, the terminal management server 3-1 proceeds to Step S115.

In Step S113, the copy source of the differential data 60-1 matches the master site of the differential data 60-1, and hence the terminal management server 3-1 updates the user information management table 202. This updating involves updating of the user information management table 202 of each of the transfer destination site #2 and the transfer source site #1.

First, the terminal management server 3-1 of the transfer source site #1 transmits, to the terminal management server 3-2 of the transfer destination site #2, a request to update the user information management table 202 (Update Request 2). This update request includes the identifier of the user, the current site #1 to be the transfer destination location 2024 after the stay period 2026 of the user information management table 202 of the transfer source site #1 elapses, a date on which the stay period 2026 elapses as the transfer date 2025, and the stay period 2026.

When receiving the update request for the user information management table 202, the terminal management server 3-2 of the site #2 acquires the identifier of the user, the transfer destination location, the transfer date, and the stay period. The terminal management server 3-2 uses the identifier of the user to search the user information management table 202, and sets the transfer destination location 2024, transfer date 2025, stay period 2026 of the retrieved record.

Next, at the transfer source site #1, the terminal management server 3-1 selects the record of the user information management table 202 corresponding to the user #1 who is to transfer, and clears the transfer destination location 2024, transfer date 2025, stay period 2026 of the selected record.

In the user information management table 202 of the transfer source site #1, the transfer schedule of the user #1 is erased therefrom. In the user information management table 202 of the transfer destination site #2, the schedule in which the user #2 returns to the transfer source site #1 after the stay period 2026 elapses is set therefor.

Next, in Step S114, the terminal management server 3-1 determines that the differential data 60-1 does not need to be deleted because the transfer source site #1 is the master site, and brings the processing to an end.

On the other hand, in Step S115, which is executed when it is determined in Step S112 that the copy source of the differential data 60 does not match the differential master site 2023, the terminal management server 3-1 deletes information on the schedule of the user information management table 202. This case corresponds to a case where the original location of the user who is to transfer is another site and the user has transferred to the site #1. Pieces of information on the schedule of the user information management table 202 are the transfer destination location 2024, the transfer date 2025, and the stay period 2026, and the terminal management server 3-1 deletes those pieces of information.

Next, in Step S116, the user who is to transfer returns to the another site (or transfers to still another site) after transferring to the current site from the another site, and hence the differential data 60-1 that has already been copied to the another site is no longer necessary. The terminal management server 3-1 therefore determines that the differential data 60-1 remaining at the site #1 needs to be deleted.

Through the processing described above, based on the schedule of the transfer from one site to another set by the scheduler 106, the terminal management server 3-1 stops the virtual machine 113 of the transfer source site and then copies the contents of each of the master image 50 and the differential data 60 to the transfer destination site, and activates the virtual machine 113 at the transfer destination site #2 with use of the copy of master image 50-ic. Further, the terminal management server 3-1 provides the information of the user information management table 202 to the terminal management server 3-2 of the transfer destination site. In this way, the user #1 can execute the work on the same virtual desktop as the one used on the previous day even at the transfer destination site #2 with use of the virtual machine 113 similar to the one provided at the transfer source site #1. In addition, the terminal management server 3-1 deletes the differential data remaining at the transfer source site when the differential master site thereof is not the transfer source site. In this way, it is possible to prevent the unnecessary copy of differential data 60-ic from remaining in the storage apparatus 5-1.

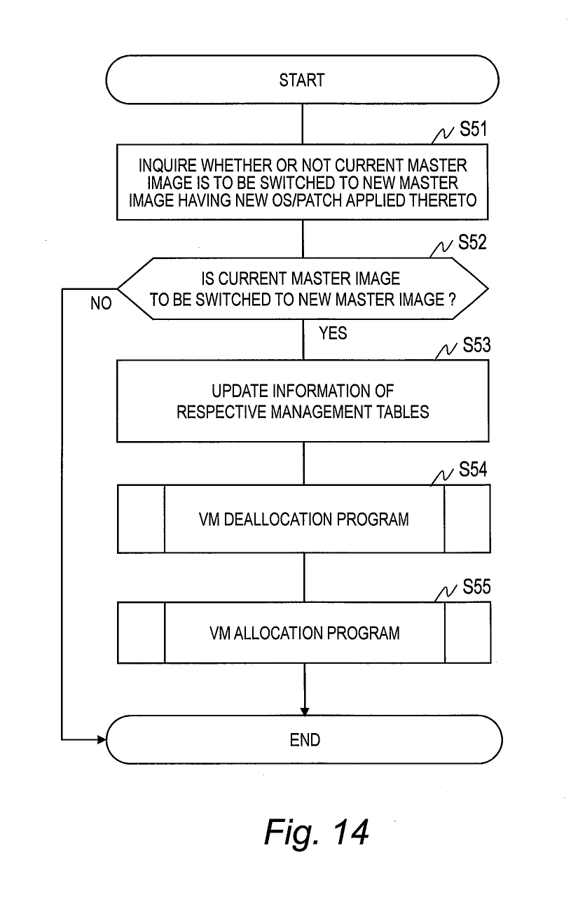

FIG. 14 is a flow chart illustrating an example of the master switching program 102. The administrator of the site prepares, with respect to the master image having the golden image, a new master image having a new OS or patch program applied thereto (hereinafter referred to as “new master image”) in a predetermined area (volume) of the storage apparatus 5. The administrator of the site further registers the new master image in the master image management table 201. The processing of FIG. 14 is executed when the user who uses the terminal 8 logs out from the virtual machine 113.

When the user logs out from the virtual machine 113 through use of the terminal 8, the terminal server 4 notifies the terminal management server 3 of the logout of the user. This logout notification includes the identifier of the user and the identifier of the virtual machine 113. When receiving the logout notification, the terminal management server 3 starts the processing of FIG. 14 in a case where the new master image is stored in the predetermined area of the storage apparatus 5.

The terminal management server 3 inquires of the virtual machine 113 (terminal 8) whose identifier is received from the terminal server 4 whether or not the current master image is to be switched to the new master image having the new OS updated or the patch program applied thereto (S51). The user who uses the virtual machine 113 responds to the inquiry. This response is one of “YES” and “NO”. When receiving the response from the virtual machine 113, the terminal management server 3 determines whether or not the user of the virtual machine 113 has selected the switching to the new master image (S52).

When the user does not desire to switch the current master image to the new master image, the terminal management server 3 brings the processing to an end without executing the processing of other steps, and then executes the logout of the terminal 8. On the other hand, when the user has selected the switching to the new master image, the terminal management server 3 proceeds to the processing of Step S53.

In Step S53, the terminal management server 3 updates each of the master image management table 201 and the user information management table 202. First, the terminal management server 3 increments the using user count 2012 of the record of the master image management table 201 corresponding to the new master image by “1”.

Next, the terminal management server 3 updates, with the identifier of the new master image, the used master image 2021 of the record of the user information management table 202 corresponding to the user in question.

In Step S54, in order to switch the master image, the terminal management server 3 transmits to the terminal server 4 a request to stop the virtual machine 113 of the user. This stop request includes the identifier of the virtual machine 113 received from the terminal server 4. The terminal management server 3 controls the terminal server 4 to execute the VM deallocation program 111 illustrated in FIG. 17, to thereby stop the virtual machine 113 allocated to the user.

In Step S55, in order to activate the virtual machine 113 of the user in question with use of the new master image, the terminal management server 3 transmits to the terminal server 4 a request to allocate a new virtual machine 113. Specifically, the terminal management server 3 selects the record of the user information management table 202 corresponding to the user in question, and acquires the used master image 2021 and differential data 2022 of the selected record. The terminal management server 3 then transmits to the terminal server 4 the allocation request for the virtual machine 113 including the acquired used master image 2021 and differential data 2022. The terminal server 4 executes the VM allocation program 110 illustrated in FIG. 16, to thereby activate the virtual machine 113 with use of the new master image.

Through the processing described above, when the user logs on to the virtual machine 113 through use of the terminal 8, the user can execute the work under the environment in which the new OS or patch program is applied. It should be noted that, in order to allow the terminal management server 3 to easily determine whether or not there is a new master image, the master image management table 201 may be provided with a field for storing the identifier of a new master image. When the identifier of the new master image is stored in this field, the terminal management server 3 can execute the processing described above.

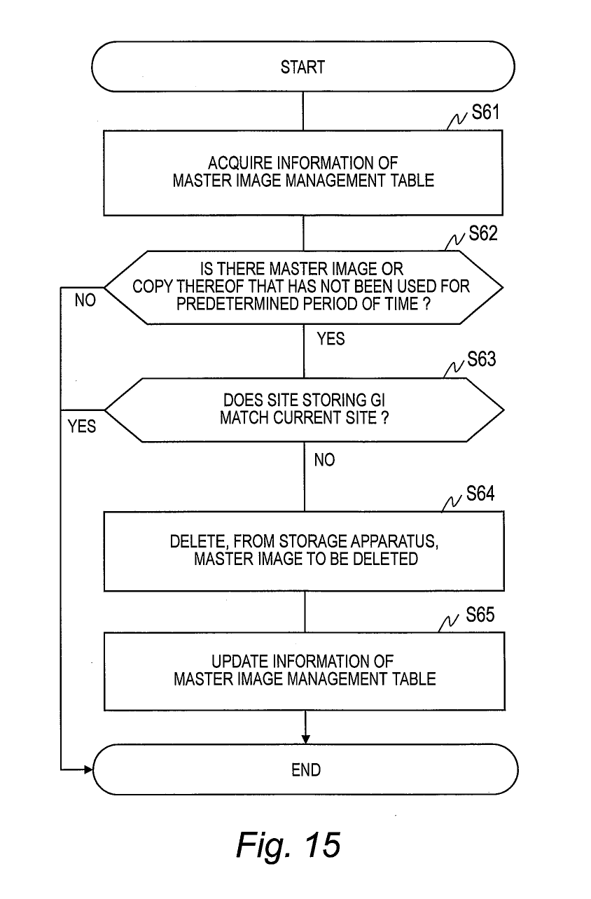

FIG. 15 is a flow chart illustrating an example of the master image deletion program 103. This processing is executed by the terminal management server 3 at predetermined cycles, for example, every month. Alternatively, the administrator or other such person may issue an instruction to activate the master image deletion program 103 through use of the input/output device 34 of the terminal management server 3.

The terminal management server 3 refers to the master image management table 201 to acquire the value of the last used date 2013 (S61). In Step S62, the terminal management server 3 determines whether or not there is a master image or copy thereof (record) in which the number of days from the date of the last used date 2013 to a current date exceeds a predetermined number of days. It should be noted that the predetermined number of days is set to, for example, 30 days, and is a threshold value of a period of time for which the master image (or copy) has not been used (non-use period). When there is a record in which the number of days from the last used date 2013 to the current date exceeds the threshold value of the non-use period, the terminal management server 3 proceeds to Step S63, and when there is no record in which the above-mentioned number of days exceeds the threshold value of the non-use period, the terminal management server 3 brings the processing to an end.

In Step S63, the terminal management server 3 refers to the record of the master image management table 201 in which the non-use period exceeds its threshold value, and determines whether or not the site 2011 storing the golden image of the master image (or the copy thereof) of the record matches the current site. When the site 2011 storing the golden image matches the current site, the terminal management server 3 brings the processing to an end. On the other hand, when the site 2011 storing the golden image does not match the current site, the terminal management server 3 proceeds to Step S64. In other words, even when the non-use period exceeds its threshold value, the terminal management server 3 excludes the golden image generated at the current site from the master image to be deleted.

In Step S64, the terminal management server 3 deletes from the storage apparatus 5 the master image (or copy thereof) whose non-use period exceeds its threshold value and whose golden image is not stored at the current site.

Next, in Step S65, the terminal management server 3 deletes the record of the master image (or the copy thereof) deleted in Step S64 from the master image management table 201 to update the master image management table 201.

Through the processing described above, the master image (or the copy thereof) whose non-use period exceeds its threshold value is deleted, and hence it is possible to prevent the master image or copy of the master image that is no longer necessary from accumulating in the storage apparatus 5, to thereby inhibit the decrease of the storage capacity of the storage apparatus 5.

In addition, the deletion of the master image whose site 2011 storing the golden image matches the current site is prohibited, and hence it is possible to protect the golden image generated at the current site.

It should be noted that, in a case where the golden image is not to be protected, the determination of Step S63 only needs to be omitted. In this case, even the golden image can be deleted when the non-use period exceeds its threshold value, and hence it is possible to reduce the size of the storage apparatus 5 for storing the image including the OS and application or the copy of the image.

FIG. 18 is a flow chart illustrating an example of the user deletion program 105. This program can be activated in response to an instruction of the administrator issued from the input/output device 34 of the terminal management server 3.

The terminal management server 3 receives from the input/output device 34 information on the user to be deleted. The information on the user to be deleted can include a user name and the identifier of the user (S101).

The terminal management server 3 inquires of the terminal server 4 whether or not the user to be deleted is coupled to the virtual machine 113. In this inquiry, the terminal management server 3 transmits the identifier of the user to the terminal server 4. The terminal server 4 detects whether or not the user having the received identifier is using the virtual machine 113, and responds to the terminal management server 3 with a detection result. The terminal management server 3 determines whether or not the user is using the virtual machine 113 based on the received detection result (S102).

When the user to be deleted is not using the virtual machine 113, the terminal management server 3 proceeds to Step S103, and controls the terminal server 4 to stop the virtual machine 113 allocated to the user to be deleted. When the user to be deleted is using the virtual machine 113, the terminal management server 3 brings the processing to an end.

In Step S103, the terminal management server 3 transmits to the terminal server 4 the deallocation request for the virtual machine 113, and controls the terminal server 4 to execute the VM deallocation program 111 illustrated in FIG. 17. The terminal server 4 decouples the virtual machine 113 allocated to the user having the received identifier from the terminal 8, and then stops the virtual machine 113 (S103).

The terminal management server 3 updates the user information management table 202, the master image management table 201, and the site-by-site differential data management table 205 (S104).

Specifically, the terminal management server 3 selects the record of the user information management table 202 corresponding to the user to be deleted, and acquires the used master image 2021 and differential data 2022 of the selected record. The terminal management server 3 selects the record of the master image management table 201 corresponding to the acquired used master image 2021, and decrements the using user count 2012 of the selected record by “1”. When the using user count 2012 becomes “0” in this case, the terminal management server 3 sets the current date as the last used date. Next, the terminal management server 3 deletes the record of the site-by-site differential data management table 205 corresponding to the acquired differential data 2022. The terminal management server 3 then selects the record of the user information management table 202 corresponding to the user to be deleted, and deletes the selected record.

Through the processing described above, the information on the user to be deleted input by the administrator from the input/output device 34 and the differential data 60 of the user are deleted. In addition, the using user count 2012 of the master image 50 is decremented after the deletion of the user, and when the value of the using user count 2012 becomes “0”, the current date is set as the last used date. In this way, when the master image 50 has not been used over the predetermined period of time, the master image deletion program 103 deletes the master image 50 from the storage apparatus 5.

As described above, in the first embodiment, after the contents of the master image 50 of the virtual machine 113 are migrated from one site to another based on the transfer schedule of the user, the master image 50 or copy of master image 50-ic whose non-use period at the transfer source site exceeds its threshold value is deleted by the master image deletion program 103, which is executed at the predetermined cycles.

In addition, the differential data 60 is deleted when the period of time during which the user stays at the another site is the predetermined period of time or longer, or when the differential master site 2023 of the differential data 60 is not the current site. In this way, it is possible to delete the differential data 60 that is not scheduled to be used, to thereby inhibit the storage capacity of the storage apparatus 5 from being consumed by the differential data 60.

### Second Embodiment

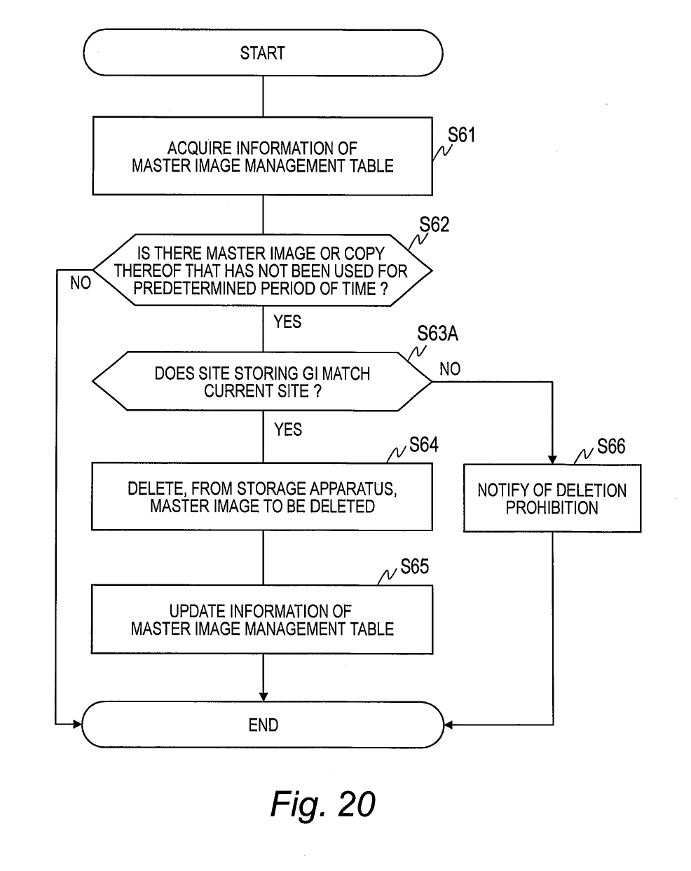

FIG. 20 illustrates the master image deletion program 103 according to a second embodiment of this invention, in which the master image (golden image) 50 generated at the own site is deleted when the non-use period of the master image exceeds its threshold value, and the master image 50 generated at another site is prohibited from being deleted.

The master image deletion program 103 of FIG. 20 is obtained by changing Step S63 of the master image deletion program 103 of the first embodiment illustrated in FIG. 15 to Step S63A and adding Step S66 thereto, and other processing steps are similar to those of the first embodiment.

In FIG. 20, the processing of Steps S61, S62, S64, and S65 are executed similarly to that of FIG. 15. In Step S63A, the terminal management server 3 refers to the record of the master image management table 201 in which the non-use period exceeds its threshold value, and determines whether or not the site 2011 storing the golden image of the master image 50 (or the copy thereof) of the record matches the current site.

When the site 2011 storing the golden image matches the current site, the terminal management server 3 proceeds to Step S64 and deletes the master image 50.

On the other hand, when the site 2011 storing the golden image does not match the current site, the terminal management server 3 proceeds to Step S66. Specifically, the master image 50 generated at another site differs in its administrator, and hence the terminal management server 3 prohibits the deletion of the master image and outputs to the input/output device 34 the fact that the deletion of the master image is prohibited, and brings the processing to an end.

Through the processing described above, in a case where the administrator who manages the site differs from one site to another, it is possible to prevent such an erroneous operation that the master image 50 that has been temporarily migrated from another site is deleted by mistake. Further, when the master image 50 generated at the own site is no longer necessary, this master image 50 is deleted even in a case where this master image 50 is the golden image, and hence it is possible to reduce the size of the storage apparatus 5 for storing the master image 50.

It should be noted that, in Step S62, it is only necessary that the terminal management server 3-1 inquire of the terminal management server 3-2 of another site as well, and determine that the master image 50 (and the copy thereof) is to be deleted when the non-use period of the master image 50 (and the copy thereof) generated at the own site exceeds its threshold value. In this case, for example, the terminal management server 3-1 of the site #1 instructs the terminal management server 3-2 of the site #2 to delete the corresponding master image 50.

### CONCLUSION

In each of the above-mentioned embodiments, although the example of the computer system including the sites #1 and #2 has been described, the number of sites is not limited thereto. In addition, although the example in which the terminal management server 3 and the terminal server 4 are implemented by different computers has been described, those servers may be provided with use of one physical computer.

It should be noted that examples of the input/output device 34 of the terminal management server 3 conceivably include a display, a keyboard, and a pointer device, but the input/output device may also be devices other than those devices. Further, a serial interface or an Ethernet interface may be used as a substitute for the input/output device 34. To be specific, an input and display of the input/output device 34 may also be substituted by the following mode. Specifically, a computer for display including a display, a keyboard, or a pointer device is connected to the above-mentioned interface, and then, the terminal management server 3 transmits information for display to the computer for display or receives the information for input from the computer for display so that the computer for display performs display or receives an input.

It should be noted that a set of at least one computer for managing an information processing system and displaying information for display of the invention of this application is sometimes referred to as “management system”. In a case where the management computer displays the information for display, the management computer is the management system. Further, a combination of the management computer and the computer for display is also the management system. Further, processing equivalent to that of the management computer may also be implemented by a plurality of computers in order to speed up management processing and achieve a higher reliability thereof, and in this case, the plurality of computers (including the computer for display in a case where the computer for display performs display) are the management system.

Further, a part or all the configurations, processing parts, processing means, and others of the computers or the like described above in this invention may be implemented by dedicated hardware.

Further, various pieces of software exemplified above in the embodiments of this invention can be stored in various storage media (for example, a non-transitory storage medium) such as an electromagnetic storage medium, an electronic storage medium, and an optical storage medium, and can be downloaded onto the computer via a communication network such as the Internet.

Further, this invention is not limited to the embodiments described above, and includes various modification examples. For example, the embodiments described above are detailed descriptions that have been given for easy understanding of this invention, and this invention is not necessarily limited to a mode that includes all the components described above.

What is claimed is:

1. A computer system, comprising:
a first site comprising a first storage apparatus, a first server computer for providing a first virtual machine, a first terminal coupled to the first server computer to use the first virtual machine, and a first management computer for managing the first storage apparatus, the first server computer, and the first terminal;
a second site comprising a second storage apparatus, a second server computer for providing a second virtual machine, a second terminal coupled to the second server computer to use the second virtual machine, and a second management computer for managing the second storage apparatus, the second server computer, and the second terminal; and
a network for coupling the first site and the second site to each other,
the first storage apparatus being configured to store a first master image including an OS and an application,
the first server computer being configured to provide the first virtual machine activated with use of the first master image to the first terminal based on an instruction issued from the first management computer,
the first management computer being configured to monitor first user information for managing information on a user who uses the first virtual machine from the first terminal, stop, when a predetermined timing at which the user is to transfer to the second site arrives, the first virtual machine and then inquire of the second management computer whether or not the first master image is stored at the second site, transmit, when the first master image is not stored at the second site, information on the first master image to the second site, transmit, to the second management computer, an instruction to generate a copy of the first master image and store the generated copy in the second storage apparatus, transmit, to the second server computer, an instruction to provide the second virtual machine activated with use of the copy of the first master image to the second terminal, and delete the first master image from the first storage apparatus when a period of time elapsed since a last use of the first master image by the first virtual machine at the first site exceeds a predetermined period of time.

2. The computer system according to claim 1,
wherein the first storage apparatus is further configured to store first differential data generated by the first virtual machine,
wherein the first server computer is further configured to allocate the first differential data to the virtual machine activated with use of the first master image to provide the virtual machine allocated with the first differential data to the first terminal based on an instruction issued from the first management computer, and
wherein the first management computer is further configured to stop, when the predetermined timing at which the user is to transfer to the second site arrives, the first virtual machine and then transmit information on the first differential data to the second site, transmit, to the second management computer, an instruction to generate a copy of the first differential data and store the generated copy in the second storage apparatus, transmit, to the second server computer, an instruction to allocate the copy of the first differential data to the second virtual machine activated with use of the copy of the first master image and provide the second virtual machine allocated with the copy of the first differential data to the second terminal, and delete the first differential data of the first site from the first storage apparatus.

3. The computer system according to claim 1, wherein the first master image comprises a copy of a master image transmitted from the second site.

4. The computer system according to claim 1, wherein the first management computer is further configured to prohibit, in a case of deleting the first master image from the first storage apparatus when the period of time elapsed since the last use of the first master image by the first virtual machine at the first site exceeds the predetermined period of time, the deletion in a case where the first master image is a copy of a master image transmitted from the second site.

5. A control method for a virtual machine in a computer system,
the computer system comprising:
a first site comprising a first storage apparatus, a first server computer for providing a first virtual machine, a first terminal coupled to the first server computer to use the first virtual machine, and a first management computer for managing the first storage apparatus, the first server computer, and the first terminal;
a second site comprising a second storage apparatus, a second server computer for providing a second virtual machine, a second terminal coupled to the second server computer to use the second virtual machine, and a second management computer for managing the second storage apparatus, the second server computer, and the second terminal; and
a network for coupling the first site and the second site to each other,
the first management computer being configured to control the first virtual machine,
the first storage apparatus being configured to store a first master image including an OS and an application,
the control method comprising:
a first step of providing, by the first server computer, the virtual machine activated with use of the first master image to the first terminal based on an instruction issued from the first management computer;
a second step of receiving, by the first management computer, first user information for managing information on a user who uses the first virtual machine from the first terminal;
a third step of monitoring, by the first management computer, the first user information, and stopping the first virtual machine when a predetermined timing at which the user is to transfer to the second site arrives;
a fourth step of inquiring, by the first management computer, of the second management computer whether or not the first master image is stored at the second site;
a fifth step of transmitting, by the first management computer, information on the first master image to the second site when the first master image is not stored at the second site as a result of the inquiry, and transmitting, to the second management computer, an instruction to generate a copy of the first master image and store the generated copy in the second storage apparatus;
a sixth step of transmitting, by the first management computer, to the second server computer, an instruction to provide a second virtual machine activated with use of the copy of the first master image to the second terminal; and
a seventh step of deleting, by the first management computer, the first master image from the first storage apparatus when a period of time elapsed since a last use of the first master image by the first virtual machine at the first site exceeds a predetermined period of time.

6. The control method for a virtual machine according to claim 5,
wherein the first storage apparatus is further configured to store first differential data generated by the first virtual machine,
wherein the first step further comprises:
allocating, by the first server computer, the first differential data to the virtual machine activated with use of the first master image to provide the virtual machine allocated with the first differential data to the first terminal based on an instruction issued from the first management computer; and
stopping, by the first management computer, when the predetermined timing at which the user is to transfer to the second site arrives, the first virtual machine and then transmitting information on the first differential data to the second site, and transmitting, to the second management computer, an instruction to generate a copy of the first differential data and store the generated copy in the second storage apparatus, and
wherein the sixth step further comprises transmitting, by the first management computer, to the second server computer, an instruction to allocate the copy of the first differential data to a second virtual machine activated with use of the copy of the first master image and provide the second virtual machine allocated with the copy of the first differential data to the second terminal, and deleting the first differential data of the first site from the first storage apparatus.

7. The control method for a virtual machine according to claim 5, wherein the first master image comprises a copy of a master image transmitted from the second site.

8. The control method for a virtual machine according to claim 5, wherein the seventh step further comprises prohibiting, by the first management computer, in a case of deleting the first master image from the first storage apparatus when the period of time elapsed since the last use of the first master image by the first virtual machine at the first site exceeds the predetermined period of time, the deletion in a case where the first master image is a copy of a master image transmitted from the second site.
